(19) United States
(12) Patent Application Publication
(10) Pub. No.: US 2021/0109434 A1
(43) Pub. Date: Apr. 15, 2021

(54) LCD projector optical system and projection method

(71) Applicant: NANHUA INTELLIGENT PRECISION MACHINE (SHENZHEN) CO., LTD., Shenzhen (CN)

(72) Inventor: Hanwen Guo, Shenzhen (CN)

(73) Assignee: NANHUA INTELLIGENT PRECISION MACHINE (SHENZHEN) CO., LTD.

(21) Appl. No.: 17/129,871

(22) Filed: Dec. 21, 2020

(30) Foreign Application Priority Data
Nov. 4, 2020 (CN) 202011220121.9

(51) Int. Cl. G03B 21/20; G03B 21/16; G03B 21/00

(52) U.S. Cl. CPC G03B 21/2073; G03B 21/16; G03B 21/208; G03B 21/006; G03B 21/2033

(57) ABSTRACT

An LCD projector optical system is provided, including an LED light source, a light guide rod, an overlapped lens module, a quarter wave plate, a brightening polarizer, a focusing lens, an LCD light valve, a field lens and a projection lens, which are sequentially arranged according to a traveling direction of light. The brightening polarizer conducts polarized light splitting for the light, wherein: one polarized light useful to the LCD light valve is transmitted, and the other polarized light useless to the LCD light valve is reflected. The reflected light enters the light guide rod and reaches the LED light source, wherein: a part of the light is reflected back by a reflective film; after passing through the quarter wave plate twice, a polarization plane of the light rotates by 90°, and then the light is utilized by the LCD light valve.

### CROSS REFERENCE OF RELATED APPLICATION

The application claims priority under 35 U.S.C. 119(a-d) to CN 202011220121.9, filed Nov. 4, 2020.

### BACKGROUND OF THE PRESENT INVENTION

### Field of Invention

The present invention relates to a field of projector, and more particularly to an LCD (Liquid Crystal Display) projector optical system and a projection method.

### Description of Related Arts

For a long time, based on illuminating the liquid crystal molecules of the transmission single LCD projector by the linearly polarized light, the light and shade images are generated through polarization detection. The illumination light from the light source is almost considered as the natural light. Therefore, during the polarization process from the natural light to the linearly polarized light, at least 50% light is filtered by the polarizer of the LCD light valve. Considering the requirements of the LCD light valve on the extinction ratio of the polarizer, the total polarization efficiency of the polarizer is generally smaller than or equal to 38%-45%. The above illumination loss alone will cause that 55%-62% energy of the single LCD projector is always useless, which radically influences the efficiency of the single LCD projector optical system and increases the heat dissipation burden of the projector optical system, thereby radically limiting the performances and applications of the single LCD projector.

The single LCD projector always adopts the simple Kohler illumination method, which not only has the low illumination efficiency, but also has the low image uniformity, causing that more heat is accumulated at the central area of the light valve and the local temperature rise of the light valve is high. Moreover, because of the inherent limitation of the LCD light valve heat dissipation technology, the output brightness of the product is further influenced, and the customer satisfaction is low. Therefore, developing a more efficient LCD projector illumination scheme, such as achieving the higher illumination efficiency through the polarized light conversion which has a high cost-performance ratio and is easily produced and achieving the better illumination uniformity and higher illumination efficiency through the critical illumination technology, is the problem needed to be solved by the present invention.

### SUMMARY OF THE PRESENT INVENTION

In order to overcome deficiencies in prior art, the present invention provides an LCD (Liquid Crystal Display) projector optical system, which effectively improves an illumination efficiency and an illumination uniformity of a single LCD projector, is easily produced and has a high cost-performance ratio.

In order to accomplish the above object, an LCD projector optical system is provided, comprising an LED (Light Emitting Diode) light source, a light guide rod, an overlapped lens module, a focusing lens, an LCD light valve, a field lens and a projection lens, which are sequentially arranged according to a traveling direction of light.

The LED light source comprises a heat conduction substrate, wherein: the heat conduction substrate has a light emitting area thereon; a plurality of light emitting chips are arranged on the light emitting area; a gap exists between adjacent light emitting chips; a reflective film, for reflecting the light, is arranged on the light emitting area except a portion corresponding to the light emitting chips.

The LCD projector optical system further comprises a quarter wave plate and a brightening polarizer, which are sequentially arranged between the overlapped lens module and the focusing lens according to the traveling direction of the light; or, the LCD projector optical system further comprises a quarter wave plate and a brightening polarizer, which are sequentially arranged between the focusing lens and the LCD light valve according to the traveling direction of the light.

Preferably, the quarter wave plate and the brightening polarizer are made of organic materials.

Preferably, a width of each gap between the adjacent light emitting chips is L; a thickness of each light emitting chip is H; L≥1.666H.

Preferably, the brightening polarizer adopts a linear polarizer; a transmission axis of the brightening polarizer is consistent with a polarization plane of an incident polarized light required by the LCD light valve; the brightening polarizer transmits a linearly polarized light required by the LCD light valve; a reflection axis and the transmission axis of the brightening polarizer are orthogonal; and the brightening polarizer reflects a linearly polarized light which is orthogonal to a polarization plane of the transmission axis.

Preferably, an angle between a fast axis of the quarter wave plate and the transmission axis of the brightening polarizer is +45°, −45°, +135°, or −135°.

Preferably, the quarter wave plate consists of two eighth wave plates; an angle between an equivalent fast axis of the two combined eighth wave plates and the transmission axis of the brightening polarizer is +45°, −45°, +135°, or −135°.

Preferably, the brightening polarizer is arranged on a diaphragm between the overlapped lens module and the focusing lens.

Preferably, the overlapped lens module comprises an incident lens, a middle lens and a diversion lens, which are sequentially arranged according to the traveling direction of the light.

The present invention further provides a projection method with the LCD projector optical system, comprising steps of: by light emitted from the LED light source, sequentially passing through the light guide rod and the overlapped lens module, then passing through the quarter wave plate, and reaching the brightening polarizer; the brightening polarizer conducting polarized light splitting for the light, wherein: one polarized light useful to the LCD light valve is transmitted, and the other polarized light useless to the LCD light valve is reflected; the two polarized lights are linearly polarized lights, whose amplitudes are same and polarization planes are orthogonal; by the polarized light useful to the LCD light valve, after passing through the brightening polarizer, uniformly illuminating the LCD light valve through the focusing lens, and then being projected through the field lens and the projection lens; by the polarized light useless to the LCD light valve, being reflected back by the brightening polarizer; by the reflected light, passing through the quarter wave plate, then passing through the overlapped lens module and the light guide rod, and reaching the light emitting area of the LED light source, wherein: a part of the light is reflected back by the reflective film on the light emitting area; by the reflected light, sequentially passing through the light guide rod and the overlapped lens module, then passing through the quarter wave plate, and reaching the brightening polarizer again, wherein: for the reflected light, after passing through the quarter wave plate twice, the polarization plane of the light rotates by 90° and becomes consistent with the transmission axis of the brightening polarizer, so that a part of the polarized light useless to the LCD light valve becomes useful and a process of polarized light conversion is completed; or comprising steps of: by light emitted from the LED light source, sequentially passing through the light guide rod, the overlapped lens module and the focusing lens, then passing through the quarter wave plate, and reaching the brightening polarizer; the brightening polarizer conducting polarized light splitting for the light, wherein: one polarized light useful to the LCD light valve is transmitted, and the other polarized light useless to the LCD light valve is reflected; the two polarized lights are linearly polarized lights, whose amplitudes are same and polarization planes are orthogonal; by the polarized light useful to the LCD light valve, after passing through the brightening polarizer, uniformly illuminating the LCD light valve, and then being projected through the field lens and the projection lens; by the polarized light useless to the LCD light valve, being reflected back by the brightening polarizer; by the reflected light, passing through the quarter wave plate, then sequentially passing through the focusing lens, the overlapped lens module and the light guide rod, and reaching the light emitting area of the LED light source, wherein: a part of the light is reflected back by the reflective film on the light emitting area; by the reflected light, sequentially passing through the light guide rod, the overlapped lens module and the focusing lens, then passing through the quarter wave plate, and reaching the brightening polarizer again, wherein: for the reflected light, after passing through the quarter wave plate twice, the polarization plane of the light rotates by 90° and becomes consistent with the transmission axis of the brightening polarizer, so that a part of the polarized light useless to the LCD light valve becomes useful and a process of polarized light conversion is completed.

The present invention has beneficial effects as follows.

Firstly, according to the present invention, through conducting polarized light splitting for the light by the brightening polarizer, the polarized light useful to the LCD light valve is transmitted, and the polarized light useless to the LCD light valve is reflected; the reflected light enters the light guide rod and reaches the LED light source, wherein: a part of the light is reflected back by the reflective film on the light emitting area of the LED light source in high efficiency, then enters the optical system again and reaches the brightening polarizer; after passing through the quarter wave plate twice, the polarization plane of the light rotates by 90° and becomes useful to the LCD light valve, moreover, the enhanced light passes through the incident interface of the light guide rod, so that the optical extend thereof does not overflow and the light is actually utilized by the LCD light valve, thereby greatly improving the illumination efficiency of the projector and saving the power consumption.

Secondly, according to the present invention, a critical illumination technology is achieved through overlapping the multiple LED light source images on the emergent surface of the light guide rod together and focusing on the LCD light valve, so as to uniformly illuminate the LCD light valve, which not only has a high illumination efficiency, but also has a high illumination uniformity.

Thirdly, the key components of the LCD projector optical system provided by the present invention, namely the quarter wave plate and the brightening polarizer, are made of organic materials, which are easy to acquire and have a high cost-performance ratio; moreover, the material supply is stable, so that the probability of influencing the normal production due to the fluctuation of the factors such as the market is greatly decreased.

### BRIEF DESCRIPTION OF THE DRAWINGS

In order to illustrate the technical solutions in the embodiments of the present invention or prior art more clearly, the accompanying drawings for describing the embodiments or the prior art are simply described below. Apparently, the accompanying drawings in the following description are only some embodiments of the present invention, and persons of ordinary skill in the art can derive other drawings from the accompanying drawings without creative efforts.

FIG. 1 is a structural sketch view of a projector optical system according to a first preferred embodiment of the present invention.

FIG. 2 is a sketch view of polarized light conversion according to the first preferred embodiment of the present invention.

FIG. 3 is a structural sketch view of an arrangement of an LED (Light Emitting Diode) light source according to the first preferred embodiment of the present invention.

FIG. 4 is a structural sketch view of a projector optical system according to a second preferred embodiment of the present invention.

### DETAILED DESCRIPTION OF THE PREFERRED EMBODIMENT

In order to make one of ordinary skill in the art better understand the technical solutions of the present invention, the present invention is described in detail with the accompanying drawings as follows. The description of the preferred embodiments is exemplary and interpretive, not for limiting the protection scope of the present invention.

It should be noted that: the similar reference characters and letters in the drawings represent the similar elements. Thus, once one element is defined in one drawing, there is no need to further define and explain the element in the subsequent drawings.

It should be noted that: the directions or positional relationships indicated by the terms such as “center”, “up”, “down”, “left”, “right”, “vertical”, “horizontal”, “inner” and “outer” are the directions or positional relationships based on the drawings, or the usual directions or positional relationships when using. These terms are only for conveniently describing the present invention and simplifying the description, not for indicating or implying the specific direction and the structure and operation in the specific direction of the devices or elements. Thus, these terms cannot be interpreted as the limitations to the present invention. Moreover, the terms such as “first”, “second” and “third” are only for distinguishing, not for indicating or implying the relative importance.

Moreover, the terms such as “horizontal”, “vertical” and “suspended” do not represent that the parts must be absolutely horizontal or suspended, but can tilt slightly. For example, the term of “horizontal” only represents that the direction is more horizontal relative to the term of “vertical”, and does not represent that the structure must be completely horizontal, but can tilt slightly.

In the description of the present invention, it should be also noted that: except clearly defined and limited, the terms of “arrange”, “mount”, “link” and “connect” should be understood broadly. For example, the connection can be fixed connection, detachable connection or integrated connection; the connection can be mechanical connection or electric connection; the connection can be direct connection, indirect connection through the medium, or the interconnection between the two elements. One of ordinary skill in the art can understand the concrete meanings of the above terms in the present invention according to the specific situation.

### First Preferred Embodiment

As shown in FIGS. 1-3, according to a first preferred embodiment, a projector optical system is provided, comprising an LED (Light Emitting Diode) light source 1, a light guide rod 2, an overlapped lens module 3, a focusing lens 4, a quarter wave plate 8, a brightening polarizer 9, an LCD (Liquid Crystal Display) light valve 5, a field lens 6 and a projection lens 7, which are sequentially arranged according to a traveling direction of light, wherein: the overlapped lens module 3 consists of an incident lens 31, a middle lens 32, and a diversion lens 33, which are sequentially arranged according to the traveling direction of the light, for overlapping multiple LED light source images on an emergent surface of the light guide rod 2 together and uniformly illuminating the LCD light valve 5.

The light guide rod 2 is a solid glass rod; an optical extend of an incident surface of the light guide rod 2 is smaller than or equal to an optical extend of the LCD light valve 5 limited by Fno (aperture) of the projection lens 7; a distance between a top portion of a light emitting area of the LED light source 1 and the incident surface of the light guide rod 2 is in a range of 0.1-0.5 mm.

Sizes of the light emitting area of the LED light source 1 and the incident surface and emergent surface of the light guide rod 2 are all 15 mm×8.57 mm; a size of a light transmission window of the LCD light valve 5 is 14.7 cm, with an aspect ratio of 16:9; the light guide rod 2 has a length of 14.5 mm and is made of K9L (China).

The quarter wave plate 8 and the brightening polarizer 9 are arranged on a piece of glass having the thickness of 0.5 mm; an incident surface of the glass bonds to the quarter wave plate 8, and an emergent surface of the glass bonds to the brightening polarizer 9; the quarter wave plate 8 and the brightening polarizer 9 are both made of organic materials, which have advantages of low price and stable supply; for example, the conventional quarter wave plate produced by Teijin Limited, Japan, can be adopted as the quarter wave plate 8, and the conventional DBEF brightening polarizer of Minnesota Mining and Manufacturing Company can be adopted as the brightening polarizer 9, which are not specifically limited. A distance between an incident surface of the quarter wave plate 8 and an emergent surface of the focusing lens 4 is 0.5 mm.

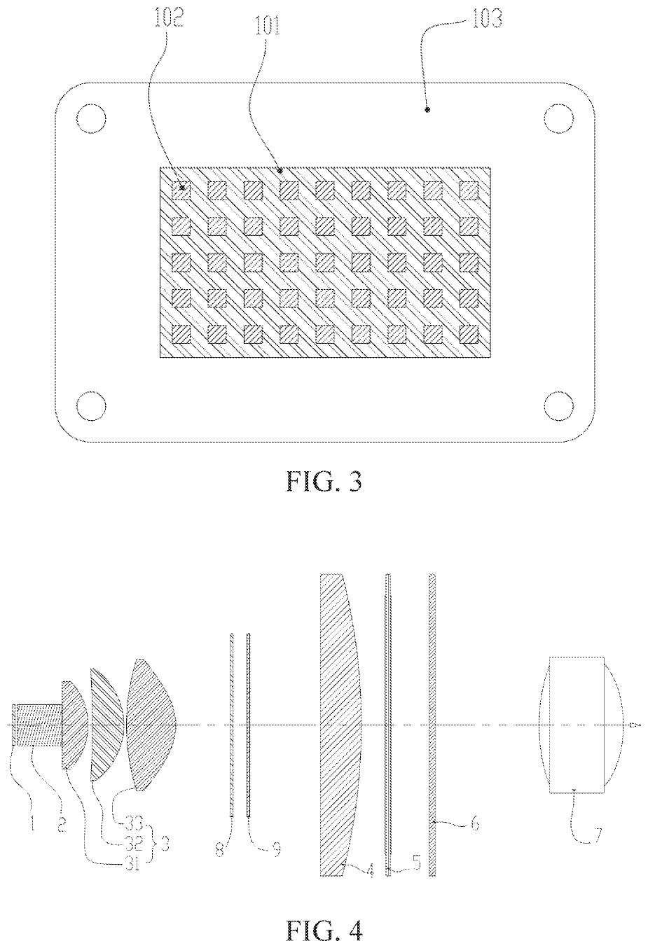

Light emitting chips 102 of the LED light source 1 are made of 40 mil blue light chips. Three schemes respectively of thirty, forty-five (as shown in FIG. 3) and sixty light emitting chips are designed for verifying the effects of the present invention. The light emitting chips 102 are uniformly arranged on the light emitting area of 15 mm-8.57 mm. The light emitting area on the heat conduction substrate 103 of the LED light source 1, except a portion where the light emitting chips 102 are arranged, is silvered to form the reflective film 101, so as to achieve the high reflectivity. The light emitting area also has a yellow fluorescent powder coating thereon; under excitation of the blue light emitting chips 102, the LED light source 1 emits the white light.

The LED light source 1 comprising thirty light emitting chips 102 have a luminous flux of 5010 Lm and a power of 45 W.

The LED light source 1 comprising forty-five light emitting chips 102 have a luminous flux of 7515 Lm and a power of 70 W.

The LED light source 1 comprising sixty light emitting chips 102 have a luminous flux of 10020 Lm and a power of 100 W.

According to the first preferred embodiment, under a situation that the quarter wave plate 8 and the brightening polarizer 9 are not arranged, the luminous flux outputs of the projectors corresponding to the above three LED light sources 1 are described as follows. The luminous flux output of the projector corresponding to the LED light source 1 comprising thirty light emitting chips 102 is 209 Lm; the luminous flux output of the projector corresponding to the LED light source 1 comprising forty-five light emitting chips 102 is 308 Lm; and the luminous flux output of the projector corresponding to the LED light source 1 comprising sixty light emitting chips 102 is 418 Lm.

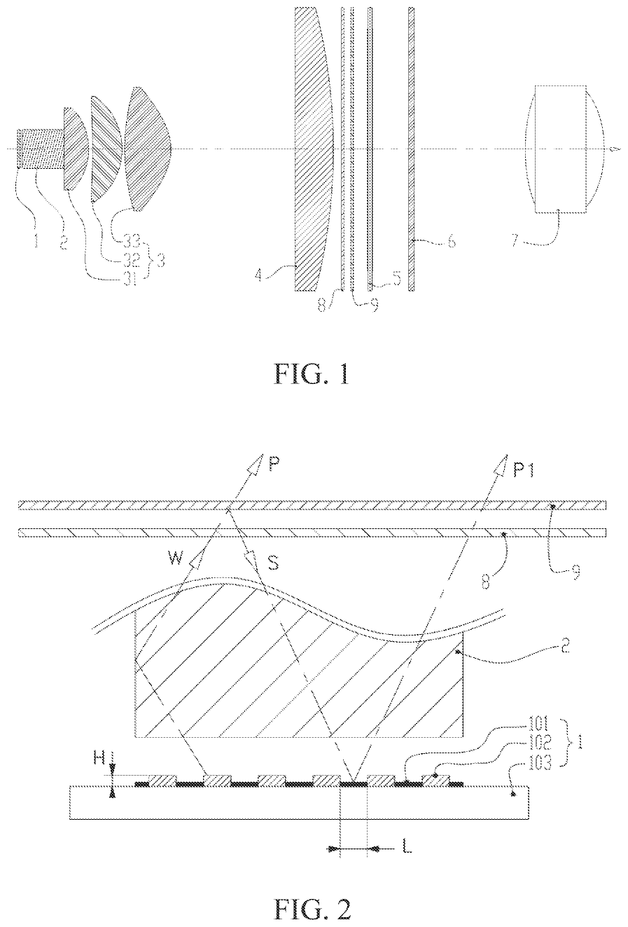

Referring to FIG. 2, according to the first preferred embodiment, under a situation that the quarter wave plate 8 and the brightening polarizer 9 are arranged, the light W emitted from any point on the light emitting area of the LED light source 1 is split by the brightening polarizer 9, wherein the light P is transmitted, and the light S is reflected. After passing through the quarter wave plate 8, the light S keeps on traveling, then passes through the gap between the light emitting chips 102, is reflected by the reflective film 101 in high efficiency, and passes through the quarter wave plate 8 again; at this time, the polarization plane of the light S rotates by 90°, the light S becomes P1 and is transmitted through the brightening polarizer 9. The luminous flux outputs of the projectors corresponding to the above three LED light sources 1 at this time are described as follows. The luminous flux output of the projector corresponding to the LED light source 1 comprising thirty light emitting chips 102 is 277 Lm; the luminous flux output of the projector corresponding to the LED light source 1 comprising forty-five light emitting chips 102 is 411 Lm; and the luminous flux output of the projector corresponding to the LED light source 1 comprising sixty light emitting chips 102 is 556 Lm.

It can be seen from the first preferred embodiment that: the illumination efficiency and output brightness of the projector is greatly increased by 1.33 times; the power consumption is saved; and the uniform illumination to the LCD light valve 5 is realized. Meanwhile, compared with the highest optical system efficiency of about 3 Lm/w in prior art (simple Kohler illumination), the efficiency of the present invention is larger than or equal to 5.5 Lm/w, which greatly improves the efficiency and uniformity.

### Second Preferred Embodiment

Referring to FIG. 4, according to a second preferred embodiment, a projector optical system is provided, comprising an LED light source 1, a light guide rod 2, an overlapped lens module 3, a quarter wave plate 8, a brightening polarizer 9, a focusing lens 4, an LCD light valve 5, a field lens 6 and a projection lens 7, which are sequentially arranged according to a traveling direction of light, wherein: locations of the quarter wave plate 8 and the brightening polarizer 9 are different from that in the first preferred embodiment; a length of the light guide rod 2 is increased to 24.5 mm; other features are same as that in the first preferred embodiment.

The brightening polarizer 9 is arranged near a diaphragm between the overlapped lens module 3 and the focusing lens 4. Combined with the optical system provided by the present invention, the term of “near” represents a range of 5 mm before and after the diaphragm.

The luminous flux outputs of the projectors corresponding to the above three LED light sources 1 are described as follows. The luminous flux output of the projector corresponding to the LED light source 1 comprising thirty light emitting chips 102 is 310 Lm; the luminous flux output of the projector corresponding to the LED light source 1 comprising forty-five light emitting chips 102 is 460 Lm; and the luminous flux output of the projector corresponding to the LED light source 1 comprising sixty light emitting chips 102 is 625 Lm.

According to the second preferred embodiment, the illumination efficiency is further improved, but the illumination uniformity of the LCD light valve 5 is decreased and the light guide rod 2 is lengthened, which still has the obvious application values.

The basic principles, main features and advantages of the present invention are described above. One of ordinary skill in the art should know that: the present invention is not limited by the above preferred embodiments; the above preferred embodiments and the description in the specification are only for illustrating the principles of the present invention; various changes and improvements made without departing from the spirit and range of the present invention should be all encompassed in the protection scope of the present invention. The protection scope of the present invention is defined by the claims and the equivalents thereof.

What is claimed is:

1. An LCD (Liquid Crystal Display) projector optical system, comprising an LED (Light Emitting Diode) light source (1), a light guide rod (2), an overlapped lens module (3), a focusing lens (4), an LCD light valve (5), a field lens (6) and a projection lens (7), which are sequentially arranged according to a traveling direction of light;
the LED light source (1) comprises a heat conduction substrate (103), wherein: the heat conduction substrate (103) has a light emitting area thereon; a plurality of light emitting chips (102) are arranged on the light emitting area; a gap exists between adjacent light emitting chips (102); a reflective film (101), for reflecting the light, is arranged on the light emitting area except a portion corresponding to the light emitting chips (102);
the LCD projector optical system further comprises a quarter wave plate (8) and a brightening polarizer (9), which are sequentially arranged between the overlapped lens module (3) and the focusing lens (4) according to the traveling direction of the light; or, the LCD projector optical system further comprises a quarter wave plate (8) and a brightening polarizer (9), which are sequentially arranged between the focusing lens (4) and the LCD light valve (5) according to the traveling direction of the light.

2. The LCD projector optical system, as recited in claim 1, wherein: the quarter wave plate (8) and the brightening polarizer (9) are made of organic materials.

3. The LCD projector optical system, as recited in claim 1, wherein: a width of each gap between the adjacent light emitting chips (102) is L; a thickness of each light emitting chip (102) is H; L≥1.666H.

4. The LCD projector optical system, as recited in claim 1, wherein: the brightening polarizer (9) adopts a linear polarizer; a transmission axis of the brightening polarizer (9) is consistent with a polarization plane of an incident polarized light required by the LCD light valve (5); the brightening polarizer (9) transmits a linearly polarized light required by the LCD light valve (5); a reflection axis and the transmission axis of the brightening polarizer (9) are orthogonal; and the brightening polarizer (9) reflects a linearly polarized light which is orthogonal to a polarization plane of the transmission axis.

5. The LCD projector optical system, as recited in claim 1, wherein: an angle between a fast axis of the quarter wave plate (8) and a transmission axis of the brightening polarizer (9) is +45°, −45°, +135°, or −135°.

6. The LCD projector optical system, as recited in claim 1, wherein: the quarter wave plate (8) consists of two eighth wave plates; an angle between an equivalent fast axis of the two combined eighth wave plates and a transmission axis of the brightening polarizer (9) is +45°, −45°, +135°, or −135°.

7. The LCD projector optical system, as recited in claim 1, wherein: the brightening polarizer (9) is arranged on a diaphragm between the overlapped lens module (3) and the focusing lens (4).

8. The LCD projector optical system, as recited in claim 1, wherein: the overlapped lens module (3) comprises an incident lens (31), a middle lens (32) and a diversion lens (33), which are sequentially arranged according to the traveling direction of the light.

9. A projection method with the LCD projector optical system as recited in claim 1, comprising steps of: by light emitted from the LED light source (1), sequentially passing through the light guide rod (2) and the overlapped lens module (3), then passing through the quarter wave plate (8), and reaching the brightening polarizer (9); the brightening polarizer (9) conducting polarized light splitting for the light, wherein: one polarized light useful to the LCD light valve (5) is transmitted, and the other polarized light useless to the LCD light valve (5) is reflected; the two polarized lights are linearly polarized lights, whose amplitudes are same and polarization planes are orthogonal; by the polarized light useful to the LCD light valve (5), after passing through the brightening polarizer (9), uniformly illuminating the LCD light valve (5) through the focusing lens (4), and then being projected through the field lens (6) and the projection lens (7); by the polarized light useless to the LCD light valve (5), being reflected back by the brightening polarizer (9); by the reflected light, passing through the quarter wave plate (8), then passing through the overlapped lens module (3) and the light guide rod (2), and reaching the light emitting area of the LED light source (1), wherein: a part of the light is reflected back by the reflective film (101) on the light emitting area; by the reflected light, sequentially passing through the light guide rod (2) and the overlapped lens module (3), then passing through the quarter wave plate (8), and reaching the brightening polarizer (9) again, wherein: for the reflected light, after passing through the quarter wave plate (8) twice, the polarization plane of the light rotates by 90° and becomes consistent with a transmission axis of the brightening polarizer (9), so that a part of the polarized light useless to the LCD light valve (5) becomes useful and a process of polarized light conversion is completed; or
comprising steps of: by light emitted from the LED light source (1), sequentially passing through the light guide rod (2), the overlapped lens module (3) and the focusing lens (4), then passing through the quarter wave plate (8), and reaching the brightening polarizer (9); the brightening polarizer (9) conducting polarized light splitting for the light, wherein: one polarized light useful to the LCD light valve (5) is transmitted, and the other polarized light useless to the LCD light valve (5) is reflected; the two polarized lights are linearly polarized lights, whose amplitudes are same and polarization planes are orthogonal; by the polarized light useful to the LCD light valve (5), after passing through the brightening polarizer (9), uniformly illuminating the LCD light valve (5), and then being projected through the field lens (6) and the projection lens (7); by the polarized light useless to the LCD light valve (5), being reflected back by the brightening polarizer (9); by the reflected light, passing through the quarter wave plate (8), then sequentially passing through the focusing lens (4), the overlapped lens module (3) and the light guide rod (2), and reaching the light emitting area of the LED light source (1), wherein: a part of the light is reflected back by the reflective film (101) on the light emitting area; by the reflected light, sequentially passing through the light guide rod (2), the overlapped lens module (3) and the focusing lens (4), then passing through the quarter wave plate (8), and reaching the brightening polarizer (9) again, wherein: for the reflected light, after passing through the quarter wave plate (8) twice, the polarization plane of the light rotates by 90° and becomes consistent with a transmission axis of the brightening polarizer (9), so that a part of the polarized light useless to the LCD light valve (5) becomes useful and a process of polarized light conversion is completed.
